(19) United States
(12) Patent Application Publication
(10) Pub. No.: US 2004/0175194 A1
(43) Pub. Date: Sep. 9, 2004

(54) Imaging devices, imaging systems, imaging methods, and real estate advertising methods

(76) Inventor: John W. Huffman, Meridian, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/382,296

(22) Filed: Mar. 4, 2003

(51) Int. Cl. G03G 21/00

(52) U.S. Cl. 399/34

(57) ABSTRACT

Imaging devices, imaging systems, imaging methods, and real estate advertising methods are described. According to one aspect, an imaging device includes a communications interface configured to receive a value from externally of the imaging device, an image sensor configured to provide image data regarding an image, processing circuitry coupled with the communications interface and the image sensor and configured to process the image data from the image sensor, and wherein the value is configured to configure a parameter of at least one of the image sensor to provide the image data and the processing circuitry to process the image data.

### FIELD OF THE INVENTION

Aspects of the invention relate to imaging devices, imaging systems, imaging methods, and real estate advertising methods.

### BACKGROUND OF THE INVENTION

Advances in image acquisition technology, and media imaging technology have been significant in recent years. Digital image acquisition devices, such as digital still cameras, provide or acquire data for images having increased resolutions while color media imaging devices including laser and inkjet devices have improved color reproduction, processing speeds, etc. The advancement of these and other imaging devices enable consumers to acquire and reproduce electronic photographs and media-based photographs of increased quality.

New custom software applications have been developed to allow users to generate professional quality brochures, sales literature, fliers, catalogs and the like. These software applications incorporate graphic images obtained from scanned photographs or taken directly with digital cameras. For instance, one example would be a sales catalog software program or template which enables a non-graphics professional user to generate a high-quality sales catalog incorporating text as well as graphics.

One exemplary application program is the HP Real Estate Document Assistant II Software available from the Hewlett-Packard Company. This exemplary application program includes a plurality of templates for fliers, postcards, calendars, brochures, newsletters, business cards, envelopes, fax cover sheets, letterhead, and labels. Images which have been obtained by a user may be incorporated into one of the templates using the application software. The described exemplary application program is utilized to generate real estate fliers or other materials for advertising real property.

Issues may exist for a user with respect to obtaining data for images and properly incorporating image data for the obtained images into the software for utilization in generating hard images. In one example, a given template may specify a landscape view of a front of a property and the user may only take a portrait image of the front of the property. In an additional example, memory capacity of a camera may be unnecessarily consumed if the resultant image is not reproduced at the same resolution as acquired. There exists a need for devices and methods which provide improved interfacing between image data acquisition systems and host systems or other devices configured to utilize the image data to create further representations of the image data.

### DESCRIPTION OF THE DRAWINGS

FIG. 1 is an isometric view of an exemplary imaging system according to one embodiment.

FIG. 2 is an illustrative representation of an image which may be produced by the imaging system in accordance with one embodiment.

FIG. 3 is a functional block diagram of an exemplary imaging device according to one embodiment.

FIG. 4 is an illustrative representation of a display of an imaging device according to one embodiment.

FIG. 5 is a flow chart of an exemplary methodology executable by a host device according to one embodiment.

FIG. 6 is a flow chart of an exemplary methodology executable by an imaging device according to one embodiment.

### DETAILED DESCRIPTION OF THE INVENTION

According to one embodiment, an imaging device comprises a communications interface configured to receive a value from externally of the imaging device, an image sensor configured to provide image data regarding an image, processing circuitry coupled with the communications interface and the image sensor and configured to process the image data from the image sensor, and wherein the value is configured to configure a parameter of at least one of the image sensor to provide the image data and the processing circuitry to process the image data.

According to another embodiment of the invention, an imaging system comprises a host configured to generate template data configured to cause the generation of a template image, an imaging device coupled with the host and configured to provide image data regarding an image and according to at least one parameter, wherein the imaging device is configured to receive a value for the at least one parameter from the host, and wherein the host is configured to receive the image data from the imaging device and to generate the template data using the image data.

According to an additional embodiment of the invention, an imaging device comprises means for providing image data regarding an image, means for processing the image data, means for receiving a value from a host external of the imaging device, means for configuring at least one of the means for providing to provide the image data according to the value, and the means for processing to process the image data according to the value.

According to still another embodiment of the invention, an imaging method comprises providing an imaging device configured to provide image data of an image, receiving a value within the imaging device from externally of the imaging device, configuring the imaging device responsive to the received value, and providing image data for an initial image using the imaging device configured according to the received value.

According to yet another embodiment of the invention, a real estate advertising method comprises providing an application program configured to cause a host to generate a template image comprising image data of a plurality of photographs of a property, providing a digital camera configured to generate the image data according to at least one parameter, obtaining a value for the at least one parameter using the host, wherein the value corresponds to a respective one of the photographs, communicating the value from the host to the digital camera, generating the image data for the respective one of the photographs using the digital camera configured according to the value, communicating the generated image data from the digital camera to the host, and generating the template image using the host and the generated image data.

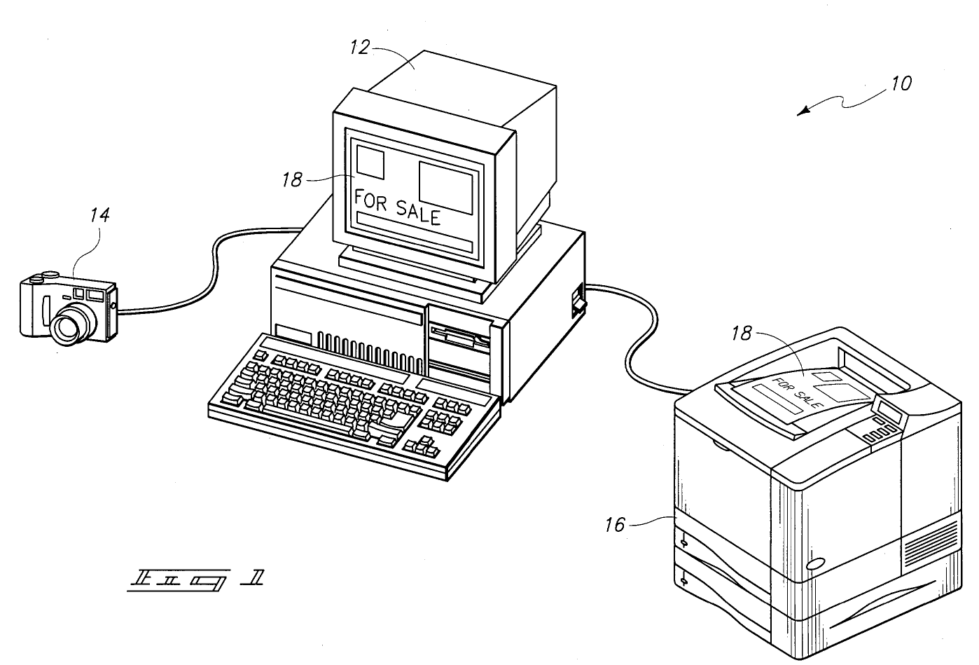

Referring to FIG. 1, an imaging system 10 is illustrated according to one exemplary embodiment. The depicted exemplary imaging system 10 includes a host 12, an imaging device 14, and a media device 16. Other configurations of system 10 are possible.

Host 12 is configured to execute programming such as application programs in one embodiment. For example, host 12 may execute application programs configured to generate template data, using image data for one or more image, and which may be used to produce template images 18. Exemplary template images 18 include fliers, postcards, calendars, brochures, newsletters, business cards, envelopes, fax cover sheets, letterhead, and labels. In but one example, host 12 is configured to execute an application program comprising the HP Real Estate Document Assistant II Software described above. Accordingly, in at least one embodiment, host 12 includes appropriate processing circuitry, such as a programmable microprocessor (not shown), configured to execute programming in conjunction with other hardware and programming. In one embodiment, host 12 comprises a personal computer (PC).

Imaging device 14 is configured as a digital camera in one embodiment. Exemplary configurations of a digital camera include a still camera, such as a Model 812 or a Model 912, both available from Hewlett-Packard Company. Imaging device 14 is arranged to generate image data for one or more image and to communicate the image data externally of the imaging device 14.

Media device 16 is configured as a printer in one embodiment. Exemplary printers include color laser printers or ink jet printers although other configurations are possible. In one embodiment, host 12 forwards template data to media device 16 which in turn produces hard images comprising template images 18. Hard images include images physically rendered upon output media, such as paper or other medium, to provide fliers, postcards, calendars, brochures, newsletters, business cards, envelopes, fax cover sheets, letterhead, and labels in one exemplary arrangement. In one embodiment, media device 16 produces hard images comprising template images 18 responsive to template data.

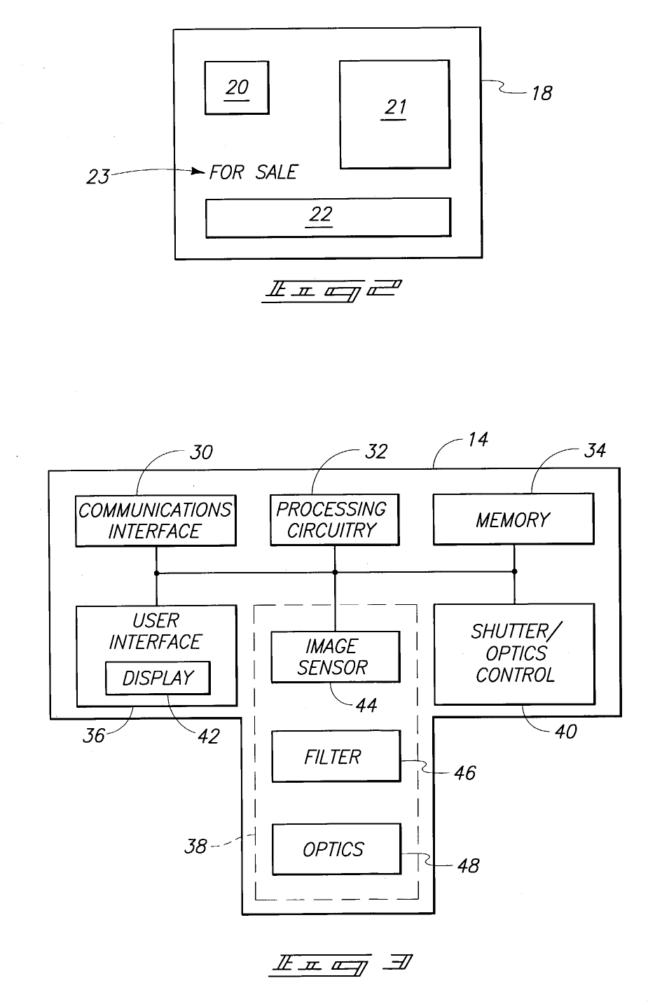

Referring to FIG. 2, an exemplary template image 18 is shown. One example of template image 18 includes a real estate advertising flier. Other template images are possible including template images for purposes other than real estate advertising and comprising more or less images and/or more or less text (if any). The depicted template image 18 includes a plurality of images 20, 21, 22 which may comprise photographs of a subject property. The images 20, 21, 22 may have different sizes and/or aspect ratios as shown. In addition, text 23 may be provided in template image 18 including information regarding the images of the property, the broker, or other appropriate information.

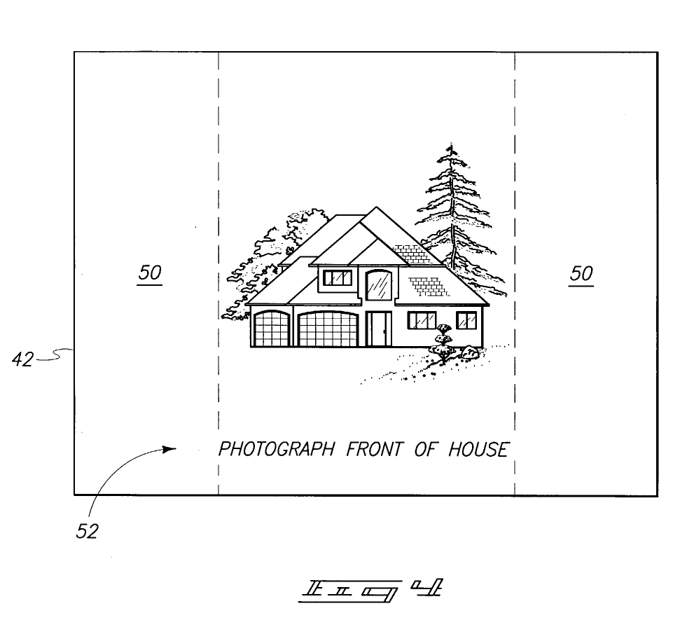

Referring to FIG. 3, imaging device 14 arranged as an exemplary digital camera is depicted. The imaging device 14 includes a communications interface 30, processing circuitry. 32, memory 34, user interface 36, imaging system 38 and shutter/optics control 40. The illustrated imaging system 38 includes an image sensor 44, a filter 46 and optics 48 comprising imaging components configured to provide digital image data of an image in the illustrated exemplary embodiment. Other configurations of imaging device 14 are possible including other components or other component configurations.

Communications interface 30 is configured to exchange data between imaging device 14 and external devices, such as host 12, media device 16, networks, etc. Communications interface 30 may be implemented in any suitable configuration to bi-directionally communicate information including digital data. For example, communications interface 30 may be embodied as a wired coupling (e.g., USB), wireless coupling (e.g., radio frequency, infrared link), flash memory interface, etc.

Processing circuitry 32 is implemented as a microcontroller in an exemplary configuration. Processing circuitry 32 is configured to execute instructions to control operations of imaging device 14 and the generation and processing (e.g., demosaicing, sharpening, denoising, compressing, etc.) of image data. Additionally, processing circuitry 32 may control operations of user interface 36 including controlling the depiction of information using a display 42 of user interface 36. Processing circuitry 32 may process data received from communications interface 30 as well as formulate external communications which may be outputted using communications interface 30.

Processing circuitry 32 may execute executable instructions stored within articles of manufacture, such as memory 34, hard disk drives, floppy disks, optical disks, flash memory, or within another appropriate device, and embodied as, for example, software and/or firmware instructions. In other embodiments, some or all of the processing of image data may be performed by processing circuitry externally located from and/or coupled with device 14 (e.g., using host 12).

Memory 34 is arranged to store digital information and instructions. Memory 34 may include a buffer configured to receive data from image sensor 44 and to store such data for processing. Memory 34 may be embodied as random access memory (RAM), read only memory (ROM), flash memory or other configuration capable of storing digital information including image data, instructions (e.g., software or firmware instructions utilized by processing circuitry 32), or any other digital data desired to be stored.

User interface 36 provides information to a user regarding operations of imaging device 14 and enables a user to control and operate functions of imaging device 14. In one embodiment, user interface 36 includes an input device such as a keypad (not shown) and display 42. Display 42 may be implemented as an LCD display to convey information to a user regarding operations of imaging device 14 as well as provide a viewfinder when generating image data of images (e.g., taking photographs).

Imaging system 38 is arranged to acquire image data which may be utilized to generate images (e.g., photographs). Image sensor 44 comprises a plurality of photosensitive elements corresponding to pixels or pixel locations and is configured to provide digital data for generating photographs. For example, area sensor 44 may comprise a raster of photosensitive elements arranged in 1,600 columns by 1,280 rows in one possible configuration. Other raster configurations are possible. Exemplary photosensitive element configurations include photodiodes, charge-coupled devices (CCDS) or CMOS devices.

Filter 46 is implemented between image sensor 44 and optics 48. Filter 46 is arranged to implement filtering operations of light received from optics 48 and prior to application of the light to sensor 44. Filter 44 may be implemented as a Bayer Mosaic filter in one embodiment. Other filter configurations and image sensor configurations are possible. For example, image sensor 44 may be configured as a Foveon X3 image sensor available from Foveon, Inc. The Foveon X3 image sensor comprises a full color sensor which provides full color (e.g., RGB) at a plurality of pixel locations without interpolation which may be performed in conjunction with use of the above-described mosaic filter. Filter 46 may be omitted in at least one embodiment. The Foveon X3 image sensor additionally permits independent querying of individual pixels or subsets of pixels. Further, an individual pixel may include color information for a plurality of colors and the individual colors may additionally be independently queried or alternately queried with other color information.

Shutter/optics control 40 implements focusing operations of optics 48, controls a shutter (not shown) and an aperture (not shown) of optics 48, performs zoom operations, and any other desired control operations of optics 48. In one embodiment, shutter/optics control 40 includes a plurality of motors which are controlled by processing circuitry 32.

As described above, host 12 may be configured to execute an application program to generate template images 18. In one embodiment, imaging device 14 may be arranged to provide image data of one or more of images 20, 21, 22 and which is utilized to create template images 18. Host 12 generates template images 18 using image data of one or more image 20, 21, 22 (FIG. 2) and received from imaging device 14. Details of individual images 20, 21, 22 to be incorporated into the template image 18 may be known before image data for the images 20, 21, 22 is acquired. For example, template images 18 may have specified layouts which define the positioning, size, and/or orientation of one or more of images 20, 21, 22 in template images 18 even before the image data for images 20, 21, 22 is created. A file within memory of host 12 or other appropriate location may include information regarding template images 18 and the file may be accessed to assist with the creation of images 20, 21, 22.

The file may include information regarding the subject matter of individual images 20, 21, 22 to be created. For example, image 20 may correspond to an entry way of a property, image 21 may correspond to a front view of a property, and image 22 may correspond to another picture of the interior of the property. Additional details may be known about individual images 20, 21, 22 including, for example, desired aspect ratio, resolution, format, and color (e.g., full color or black and white) before the image data for the images 20, 21, 22 is generated. The details may be stored within an appropriate file and accessed by host 12.

In one embodiment, host 12 is configured to communicate information to imaging device 14 to assist with the generation of image data for one or more of images 20, 21, 22. Imaging device 14 is arranged to generate the image data according to one or more parameters. Exemplary parameters include aspect ratio, resolution, format (e.g., landscape vs. portrait), color versus black, and white. Host 12 may access information regarding a template image 18 to be generated and information regarding individual images 20, 21, 22 of the template image 18. The accessed information may include values for the plurality of parameters for the images 20, 21, 22. Host 12 is configured in one embodiment to communicate one or more values to imaging device 14 to assist with the generation of image data for images 20, 21, 22. In one embodiment, the values may define the appropriate aspect ratios, resolutions, formats, colors, or other parameters for the image data for images 20, 21, 22 to be generated. As described below, the values may control and/or configure the imaging device 14 to obtain desired image data according to respective template images.

Accordingly, in one embodiment, host 12 accesses a file corresponding to a template image 18 to be generated. Host 12 selects respective values corresponding to the respective images 20, 21, 22 to be imaged (e.g., selects values to control acquisition of image data by device 14 and corresponding to placement of the image data within template image 18 corresponding to the respective images 20, 21, 22). Host 12 communicates the selected values to imaging device 14 to acquire the respective image data for images 20, 21, 22 according to the communicated values and/or other information.

Instructional text may also be communicated from host 12 to imaging device 14 to assist with imaging operations according to one embodiment. The instructional text may be utilized by an operator of imaging device 14 to create image data for images 20, 21, 22. The instructional text communicated to imaging device 14 may be depicted using display 42 during imaging operations. For example, when image data is being acquired for image 21 using imaging device 14, processing circuitry 32 may be configured to control the display 42 to depict the text comprising for example, “Please take a picture of the front of the property” responsive to information received from host 12. The instructional text may be disregarded following acquisition of the respective image data.

The above describes exemplary parameters of imaging device 14 which may be specified by host 12 during the generation of image data using imaging device 14. The parameters are illustrative and values of any other parameters which may be varied during imaging by imaging device 14 may be defined by host 12 in other embodiments.

Imaging device 14 is configured to receive the communicated information including values, instructional text or other information using communications interface 30 and the received information may be stored within memory 34. The communicated information may be accessed during imaging operations. Imaging according to the communicated information may be initiated in different ways. In one example, a user may select a mode of imaging via user interface 36 wherein the communicated information is utilized. Alternately, processing circuitry 32 may automatically utilize the communicated information upon receipt to begin imaging operations. Imaging using the communicated information may be initiated in any other appropriate manner.

The communicated information may be utilized to control and/or configure appropriate components of imaging device 14 for imaging. In one embodiment, received values are utilized to configure processing circuitry 32 and/or image sensor 44 during the generation of image data. As mentioned above, the values may configure the processing circuitry 32 and/or image sensor 44 to acquire image data for images 20, 21, 22 according to defined aspect ratios, resolutions, formats, colors, or other parameters. For example, if a Foveon sensor is utilized as image sensor 44, the resolution of image data acquired by the sensor 44 may be set according to a received value. Processing of image data by processing circuitry 32 may be adjusted responsive to received values. For example, processing circuitry 32 may disregard image data for some pixel locations if the desired resolution is less than the resolution of data available from image sensor 44. In another example, processing circuitry 32 may omit demosaicing operations if host 12 specifies that fully populated color data is not desired as indicated by a communicated value. The described configurations are exemplary and other configuring of imaging device 14 responsive to information from host 12 is possible.

In at least one embodiment, host 12 is configured to provide a plurality of values for respective images 20, 21, 22 to obtain different images according to the template image 18 to be generated. The values may be initially defined or instructions may be communicated to configure imaging device 14 to utilize one or more initial value to obtain image data for first image 20, and one or more different value for obtaining image data for second and/or third images 21, 22. Accordingly, imaging device 14 may be initially configured (e.g., using an initial received value) according to a first configuration to obtain image data for one image, and thereafter reconfigured (e.g., using another received value) to obtain image data for another image according to another configuration.

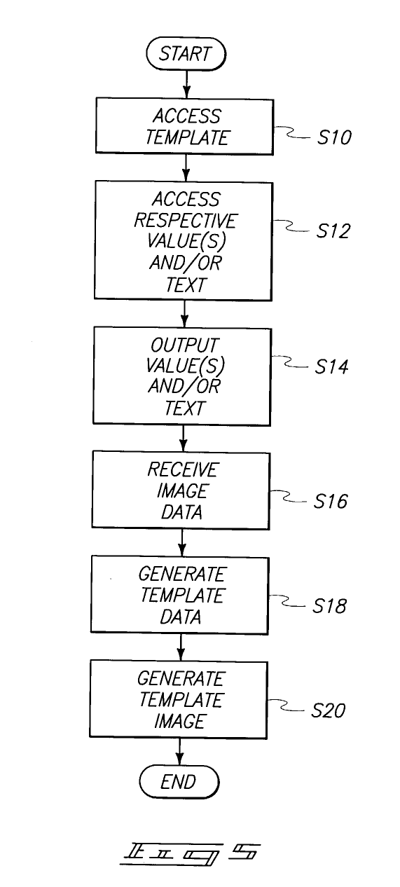

As mentioned above, processing circuitry 32 may control depiction of received text (e.g., instructional text) using display 42. In one embodiment, processing circuitry 32 may further control a configuration of display 42 of user interface 36 presented to a user to further assist the user with imaging. For example, referring to FIG. 4, if a received value indicates portrait format is desired, black bars 50 may be created on vertical sides of display 42 operating as a view finder to assist the user with composing a portrait image (e.g., proper placement of the subject being imaged). Exemplary instructional text 52 is also shown to assist a user with imaging operations.

Following appropriate acquisition, the image data for images 20, 21, 22 may be communicated to host 12 using communications interface 30. Host 12 is configured to receive, process and arrange the image data to prepare the template image 18. In one embodiment, processing implemented by host 12 may be reduced inasmuch as the imaging device 12 obtained the image data according to the information received from host 12.

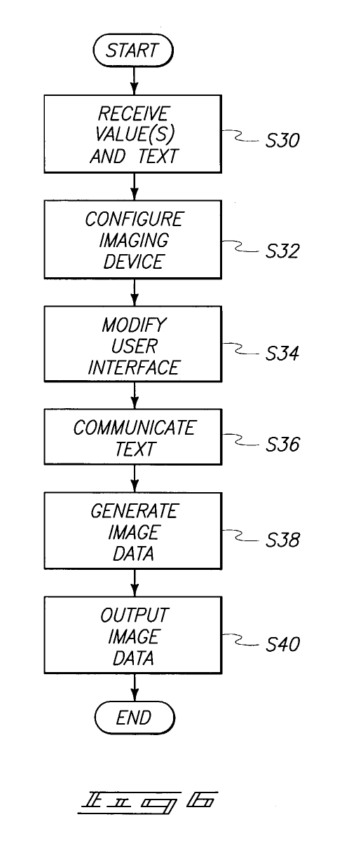

Referring to FIG. 5, an exemplary methodology illustrates operations of host 12 for providing information to imaging device 14 and receiving image data therefrom. In one embodiment, the exemplary methodology may be executed within host 12. The methodology is provided to describe exemplary operations and other methods may be used including more, less and/or alternative steps.

At a step S10, processing circuitry of the host 12 is arranged to access a file for the generation of a respective template image. A user may select one of a plurality of a templates to provide the desired output.

At a step S12, the host 12 may access one or more respective value (e.g., from the file) corresponding to the accessed template.

At a step S14, the host 12 communicates the one or more value and/or other information (e.g., instructional text) to the imaging device 14.

At a step S16, the host 12 awaits the reception of image data for one or more images from the imaging device 14.

At a step S18, the host 12 generates template data using the received image data. For example, processing circuitry of the host 12 incorporates the received image data into appropriate image fields of the accessed template and may provide a single file for the template image including image data for a plurality of images 20, 21, 22 (if provided) and associated text 23. Text 23 may be extended by a user via host 12.

At a step S20, the processing circuitry of the host 12 may generate a template image which may be depicted using a display of the host 12, physically rendered upon output media using media device 16, and/or otherwise communicated externally using an appropriate network or other medium.

Referring to FIG. 6, an exemplary methodology illustrates operations of processing circuitry 32 of imaging device 14. Other methods are possible including more, less and/or alternative steps.

At a step S30, the imaging device 14 receives the one or more values, text and any other communicated information.

At a step S32, processing circuitry 32 of the imaging device 14 configures the device 14 according to the received values. Exemplary configuring includes configuring the processing circuitry 32 and/or image sensor 44 of the imaging device 14 according to the values defining one or more of an aspect ratio, resolution, format and color of images to be produced.

At a step S34, the processing circuitry 32 configures or modifies the display 42 of user interface 36 to assist a user with image data acquisition and responsive to information communicated from host 12.

At a step S36, the processing circuitry 32 of the imaging device 14 operates to communicate the received text (e.g., via display 42) to a user to assist with imaging operations.

At a step S38, the processing circuitry 32 of the imaging device 14 produces the appropriate image data for one or more image 20, 21, 22.

At a step S40, the processing circuitry 32 of the imaging device 14 communicates the image data to an appropriate recipient, such as the host 12, for producing the template image 18.

At least some embodiments of the invention assist with automation and simplification of integration of graphics images obtained from imaging devices 14 into software applications. At least one embodiment of the invention enables host 12 to download values corresponding to settings of an imaging device 14 to the imaging device 14, as well as directions for use, to simplify image acquisition for a user using the imaging device 14.

Advance knowledge of the desired template image 18 to be created permits optimization of operations of imaging device 14 during image data acquisition. Information from host 12 and received by imaging device 14 regarding desired resolution may be utilized to efficiently store images during acquisition stages. Other communicated information may assist a user with composing photographs. A user may follow instructions provided by downloaded instructional text and conveniently operate the imaging device 14 having one or more setting selected by the host 12.

Additionally, host 12 may communicate a value instructing processing circuitry 32 of imaging device 14 to “crop” display 42 used as a viewfinder during imaging operations to simulate an aspect ratio of the final image when merged into the template image 18 using host 12. Embodiments of the invention may be used to assist an inexperienced user with acquiring images of improved composition.

The exemplary configurations described herein may be utilized with the above-described real estate programs to facilitate generation of real estate promotional materials. Other embodiments of the invention facilitate generation of other types of materials which may pertain to other types of subject matter.

The protection sought is not to be limited to the disclosed embodiments, which are given by way of example only, but instead is to be limited only by the scope of the appended claims.

What is claimed is:

1. An imaging device comprising:
a communications interface configured to receive a value from externally of the imaging device;
an image sensor configured to provide image data regarding an image;
processing circuitry coupled with the communications interface and the image sensor and configured to process the image data from the image sensor; and
wherein the value is configured to configure a parameter of at least one of the image sensor to provide the image data and the processing circuitry to process the image data.

2. The device of claim 1 wherein the parameter defines one of an aspect ratio, resolution, format, and color of the image data.

3. The device of claim 1 further comprising a memory configured to store the value, and wherein the processing circuitry is configured to access the value from the memory.

4. The device of claim 1 further comprising a user interface, and the value is configured to alter a configuration of the user interface presented to a user.

5. The device of claim 4 wherein the communications interface is configured to receive instructional text, and the processing circuitry is configured to control the user interface to depict the instructional text.

6. The device of claim 1 wherein the value is configured to configure the parameter of the image sensor.

7. The device of claim 1 wherein the value is configured to configure the parameter of the processing circuitry.

8. An imaging system comprising:
a host configured to generate template data configured to cause the generation of a template image;
an imaging device coupled with the host and configured to provide image data regarding an image and according to at least one parameter;
wherein the imaging device is configured to receive a value for the at least one parameter from the host; and
wherein the host is configured to receive the image data from the imaging device and to generate the template data using the image data.

9. The system of claim 8 wherein the template data is configured to cause the generation of the template image comprising a plurality of images, and wherein the value corresponds to a respective one of the images.

10. The system of claim 8 wherein the value configures an image sensor of the imaging device to obtain the image data.

11. The system of claim 8 wherein the value configures processing circuitry of the imaging device to control processing of the image data.

12. The system of claim 8 wherein the imaging device comprises a digital still camera.

13. The system of claim 8 wherein the host is configured to communicate instructional text to the imaging device, and the imaging device is configured to depict the instructional text to a user to assist with the provision of the image data.

14. An imaging device comprising:
means for providing image data regarding an image;
means for processing the image data;
means for receiving a value from a host external of the imaging device;
means for configuring at least one of:
the means for providing to provide the image data according to the value; and
the means for processing to process the image data according to the value.

15. The device of claim 14 wherein the means for configuring comprises means for configuring both of the means for providing and the means for processing.

16. The device of claim 14 wherein the value is configured to provide image data having one of a predefined aspect ratio, predefined resolution, predefined format, and predefined color.

17. An imaging method comprising:
providing an imaging device configured to provide image data of an image;
receiving a value within the imaging device from externally of the imaging device;
configuring the imaging device responsive to the received value; and
providing image data for an initial image using the imaging device configured according to the received value.

18. The method of claim 17 further comprising:
receiving another value within the imaging device,
reconfiguring the imaging device responsive to the receiving the another value; and
providing image data for another image using the imaging device reconfigured according to the another received value.

19. The method of claim 18 further comprising communicating the image data for the initial image and the another image to a host.

20. The method of claim 17 wherein the receiving comprises receiving the value via one of a wireless interface, flash memory interface, and wired interface.

21. The method of claim 17 wherein the providing comprises providing a digital still camera.

22. The method of claim 17 further comprising communicating the image data to a host.

23. The method of claim 22 further comprising:
generating template data including the image data using the host, and wherein the template data is configured to cause the generation of a template image;
selecting the value using the host and corresponding to placement of an image of the image data within the template image; and
communicating the value from the host to the imaging device.

24. The method of claim 17 wherein the providing the imaging device comprises providing an imaging device comprising a display, and configuring the display according to the value.

25. A real estate advertising method comprising:
providing an application program configured to cause a host to generate a template image comprising image data of a plurality of photographs of a property;
providing a digital camera configured to generate the image data according to at least one parameter;
obtaining a value for the at least one parameter using the host, wherein the value corresponds to a respective one of the photographs;
communicating the value from the host to the digital camera;
generating the image data for the respective one of the photographs using the digital camera configured according to the value;
communicating the generated image data from the digital camera to the host; and
generating the template image using the host and the generated image data.

26. The method of claim 25 further comprising:
communicating instructional text to the digital camera; and
displaying the instructional text using the digital camera before the generating.
